(19) United States
(12) Patent Application Publication
(10) Pub. No.: US 2008/0215385 A1
(43) Pub. Date: Sep. 4, 2008

(54) Methods and systems for services reservations

(76) Inventor: Colin S. Veitch, Pinecrest, FL (US)

Correspondence Address: DON J. PELTO;Sheppard, Mullin, Richter & Hampton LLP, 1300 I STREET, NW, 11TH FLOOR EAST, WASHINGTON, DC, 20005, US

(21) Appl. No.: 11/713,079

(22) Filed: Mar. 2, 2007

(51) Int. Cl. G06Q 10/00

(52) U.S. Cl. 705/6

(57) ABSTRACT

The present invention relates to systems and methods for making reservations for services provided to guests by a host organization through a central reservation system, wherein the central reservation system comprises a video monitor system, a paging system, and a communications network, wherein the central reservation system is connected to the video monitor system and the paging system via the communications network, and wherein the central reservation system maintains reservation data for one or more provided guest services at a host organization.

### FIELD OF THE INVENTION

The present invention relates to systems and methods for checking availability of, making, changing, and canceling reservations for dining, activities and other services offered on a cruise ship, at a resort hotel, spa, or any such similar host organization providing one or more guest services that may require reservations or appointments, said systems and methods designed to streamline and improve the reservation system over the problems inherent in traditional systems, while providing guests with more freedom, options and control over the reservation process. The present invention will thus allow guests to better enjoy their experiences at host organizations by being better able to take advantage of amenities offered, and by having control of their planning and at their convenience. The systems and methods will offer guests the benefits of access, selection and immediacy in making, viewing or changing reservations. The present invention also simplifies the host organization's booking process, by providing a centralized reservation management system that can be used for all bookings, regardless of type of service.

### BACKGROUND OF THE INVENTION

By way of an example of dining reservations, but not to limit the invention, traditionally cruise ships have provided only one dining option, a formal dining room with two seatings, one of which is earlier than the other. The formal dining room, limited by its singular nature, can only provide one ambiance and a limited number of food options. This lack of variety, for example, may risk decreasing the pleasure of and creating monotony for some guests over the course of a cruise.

In the traditional formal dining room, a guest is normally assigned to a particular table with specific other guests on the cruise ship, some of whom he/she may not have met prior to the cruise, and with whom he/she may not have a great deal in common. The guest is constrained to this table and group for the duration of the cruise. Further, often in the formal dining room, certain dress requirements must be met. Thus, the traditional formal dining room can often make guests suffer through uncomfortable situations and has the potential to make a guest's cruise less enjoyable.

The traditional formal dining room does, however, have certain advantages for the cruise ship crew. As there is only one restaurant with two seating times, there is no need to allow guests to make reservations. As a result, seating data can be easily tracked and managed. Further, there is no need to notify guests when their table is ready.

Given the constraints to guests that are presented by the traditional dining system, a new system allowing for more freedom of choice, such as that originally developed by NCL Corporation Ltd. under the trademarks Freestyle Cruisin® and Freestyle Dinin®, would be advantageous. In such a system, cruise ship guests may choose from a variety of restaurants aboard the cruise ship, thus being able to enjoy different ambiances, with formal or informal dress, and to sample various types of cuisine. In such a system, cruise ship guests are also free to sit with whomever they please—their families, a group of friends, or other cruise ship guests. In such a system, cruise ship guests can also choose when they dine, will not be confined to dining at a time that may be too early or too late for their tastes, and can choose their attire. In such a system, cruise ship guests are not constrained in their dining options, but instead have the freedom to choose when, where and with whom they dine.

Thus, the present invention, again using the cruise ship dining reservation system as an example only, as designed, will alleviate the problems of the traditional cruise ship dining system and deal with the challenges that will arise upon a shift from the conventional limits of cruise ship dining to a freestyle dining reservation system. At its essence, this invention aims to provide cruise ship guests with more freedom and allow them to better enjoy their cruise, and will simplify the host organization's booking process by providing a centralized reservation management system that can be used not only for dining reservations but for all reservations, regardless of type of service. Some of the challenges that come with a shift to such a freestyle reservation system is that the patrons will need to know what options are available to them, including, for example, options pertaining to open timeslots, table and venue choices, etc. The host organization's management will need to be able to take, cancel and change these reservations, and to notify guests when their reservations are confirmed and their tables, seats or timeslots are available.

The systems and methods of the present invention are not limited to cruise ships and dining reservations, but can be used at any host organization providing guests with one or more of any variety of services including activities, shows, dining, excursions, art auctions, health and wellness programs, cooking demonstrations, and other services, wherein reservations may be needed. The systems and methods of the present invention are designed to streamline and improve the reservation system over the problems inherent in traditional systems, while providing guests with more freedom, options, and control over the reservation process.

### SUMMARY OF THE INVENTION

In one embodiment, the present invention is a freestyle reservation system comprising one or more services provided by a host organization; a video monitor system; a central reservation system; a paging system; and a communications network, wherein the central reservation system is connected to the video monitor system and the paging system via the communications network; wherein the central reservation system maintains reservation data for the one or more services; and wherein the freestyle reservation system is associated with a particular host organization, such as but not limited to a cruise ship, resort hotel, spa, etc., and wherein the host organization provides one or more services that may require reservations. By “associated with” it is meant that the host organization utilizes the freestyle reservation system described herein for showing, making, changing, or canceling reservations for one or more of the services it provides guests or for displaying information about one or more of the services the host organization provides to guests.

In another embodiment, the central reservation system comprises a computer which acts as a server for the system and provides a central database of reservations for all services.

In yet another embodiment, the video monitor system comprises one or more video monitors, and the central reservation system computer is connected to the one or more video monitors via the communications network and provides real-time reservation information to the one or more video monitors.

In another embodiment, the video monitors are equipped with touch screens. In another specific embodiment, each video monitor may be a touch-screen television, computer monitor, LCD monitor, CRT monitor, LCoS monitor, DLP monitor, plasma monitor, the screen on a personal data assistant, and/or the screen on a telephone.

In a specific embodiment, the video monitor system may connect to the central reservation system through a dial-up, digital subscriber line, cable modem, fiber, local area network, and/or wide area network connection.

In yet another embodiment, the paging system comprises a central paging system computer; a central paging system transmitter; and one or more guest pagers, wherein the central paging system computer is connected to the central paging system transmitter; and wherein the central paging system transmitter activates the one or more guest pagers by transmitting RF (radio frequency) signals in the appropriate frequency range.

In another embodiment, the central paging system computer is connected to the central reservation system computer via the central reservation system network. In yet another embodiment, the freestyle reservation system further comprises one or more guest rooms containing televisions or other similar display mechanisms, wherein the one or more video monitors comprises one or more of the televisions or similar display mechanisms.

In yet another embodiment, the freestyle reservation system communications network is integral with the host organization's existing communications network.

In another embodiment, the freestyle reservation system can be accessed using a menu on the guest room television or similar display mechanism using a remote control. In another embodiment, guests may view, make or change their reservations for any services.

In another embodiment, guests can view and make reservations at the physical site where any of the host organization's services are provided.

In a specific embodiment of the present invention, services may be provided guests by an external service provider; i.e., an organization outside the host organization. The services supplied by the external provider may connect to the central reservation system so guests may make or change reservations, or view service information, for services provided by the external service provider just as they may for services provided by the host organization.

In a specific embodiment, an external service provider may contract with the host organization, and/or pay a fee, or enter into some other form of agreement with the host organization to allow its services to be a part of the central reservation system. Examples of such external services and providers offering services to guests at the host organization include, but are not limited to, restaurants, restaurant chains, golf courses, athletic facilities, racquet clubs, casinos, tour guides or similar organizations providing excursions from the host organization, theaters, spas, hotels, cruise ships, airlines, bus lines, taxi services, limousine services, cleaning services, laundry services, swimming pools, or providers of virtually any other guest service.

In another embodiment, guests may be able to view information about the services. Such information may include menus, hours of operation, levels of service, wine lists, drink menus, drink specials, dress code, age requirements, costs of admission, costs for services, costs of items, etc.

In yet another embodiment, guests may access the freestyle reservation system remotely; i.e., from a location outside the host organization. For example, guests may access the system so as to make reservations before arrival at the host organization, for a service during a future or subsequent visit.

In yet another embodiment, in order to make reservations before arrival at the host organization for a service during a future or subsequent visit, guests can access the freestyle reservation system remotely via any of various means including, but not limited to, the internet, electronic mail, a menu driven system accessed by traditional land-based or mobile phones, a personal data assistant (PDA), a BlackBerry®, home computer or laptop, or other similar instrumentality. Security for access to the freestyle reservation system from future or repeat guests outside the host organization may utilize, for example, data encryption keys, user authorization codes, a unique user name and password, or other means known to those of ordinary skill in the art.

In another embodiment, guests are paged at a preset time to remind them of their reservations.

In another embodiment, information as to the availability of tables, seatings, or timeslots may be input to and updated on the central reservation system so as to dynamically track the reservation status of tables, seatings, or timeslots in real time.

In another embodiment, such reservation status information may include, in the example of a restaurant, when the table is set and ready for guests, when the table is occupied with menus distributed, when orders are taken, when food is on its way, when the meal is under way, when the meal is over and the table ready for its bill, and when the table is waiting to be cleared and re-set.

In another embodiment, such reservation status information may be input by waiters or other service staff.

In another embodiment, information as to the availability of tables, seatings, or timeslots may be input to and updated on the central reservations system by means of, e.g., a radio frequency hand-held device, by sensors and/or remote surveillance.

In another specific embodiment, this real-time, up-to-date reservation status information may be accessed and viewed by guests via the video monitor system, so they may gauge the amount of time before their tables, seatings or timeslots become available, and plan accordingly.

In another specific embodiment, the reservation status information may be displayed on monitors available to restaurant galley crew or other service staff or management to allow them to time their production to the status reports pertaining to table, seating or timeslot usage. The information regarding availability of tables, seatings or timeslots that is accumulated at the end of any particular work period may also be stored and used to provide productivity data to the service's management, to aid in budgeting, purchasing, business development, etc.

In another embodiment, guests can make reservations for a specific number of people, or request reservations for themselves or with a particular guest or guests.

The reservation system may pertain to data for reservations, appointments, bookings, retainments, time slots, or other such allocations of time for services.

In a specific embodiment, the services provided may be those of a food-serving establishment, such as a restaurant, café, bistro, pizza parlor, sushi bar, etc. The services could also be provided by a beverage-serving establishment, such as a café, coffee shop, espresso bar, bar, cocktail lounge, nightclub, pub, tavern, etc.

In another embodiment, the services could be personal services provided by, e.g., room service, dry cleaning, laundry, child sitting, butler or maid services, etc. Services provided could also be entertainment, such as shows, a disco, karaoke, theater, bowling, parties, and concerts.

In another specific embodiment of the present invention, services provided could be athletic activities; for example, rock wall climbing, surfing, golf, racquet sports, aerobics classes, step classes, Pilates classes, Spinning® classes, and yoga classes. The services could also be activities such as excursions, auctions, and children's activities.

In yet another specific embodiment, the paging system of the freestyle reservation system herein described may connect to the central reservation system through a dial-up, digital subscriber line, cable modem, fiber, local area network, and/or wide area network connection.

### BRIEF DESCRIPTION OF THE DRAWINGS

FIG. 1 is a block diagram of one specific embodiment of a described freestyle reservation system 100.

FIG. 2 is a block diagram of another specific embodiment of a described freestyle reservation systems 100.

FIGS. 3 and 4 are block diagrams of specific embodiments of video monitor system 20.

FIG. 5 is a block diagram of a specific embodiment of a paging system 40.

### DETAILED DESCRIPTION OF THE EMBODIMENTS

### Definitions

As used herein, the term “reservation” refers to any appointment, booking, retainment, timeslot, or setting aside of time for a guest to participate in one or more services provided by a host organization.

As used herein, the term “services” may refer to any guest services provided by a host organization, or may refer to services provided for the host organization's guests by another entity outside of and/or separate from the host organization, for which reservations may be required. Such services for which reservations may be made using the present invention include but are not limited to: dining establishments, including any establishment where food may be consumed, such as formal restaurants, restaurants, cafés, coffee shops, bistros, sushi bars, pizza parlors, etc.; bars, lounges, coffee shops and any other establishments at which alcoholic and non-alcoholic beverages may be consumed; personal services such as room service, dry cleaning, laundry, child sitting, butler service, etc.; attendance at entertainment and at venues such as discos, theaters, parties and shows; spas, including services for hair, nails, massage, etc.; sporting and other activities including rock wall climbing, surfing, court time, tee time for golf, etc.; health and fitness programs such as Pilates, yoga, Spinning®, step classes, aerobics, etc.; scheduled children's activities and classes; excursions; auctions; casinos; cooking demonstrations; and so forth.

As used herein, the term “host organization” refers to any organization that provides guests with one or more services, for which reservations may be required. Such host organizations may include but are not limited to cruise ships, resorts and hotels, spas, bed and breakfasts, organized tour providers, travel agencies (e.g., Expedia® or Priceline®), concierge services (e.g., Redbutler® or VIPdesk®), etc. The term “guests” refers to the clientele of the host organization, who are accessing and interacting with the central reservation system and making reservations for use of the host organization's provided services.

As used herein, the term “paging signal” refers to signals transmitted by the central paging transmitter to guest pagers, and may be comprised of radio frequency (RF) signals, infrared signals, or other wireless communication signals as understood by one of skill in the art. “Paging signal” can also refer to signal information as sent by electronic mail, telephone, or any other type of traditional transmitting means such as wire or cable.

As used herein, the term “guest pagers” refers to devices capable of receiving paging signals sent to guests from the central paging transmitter. Guest pagers may be mobile devices, or stationary and/or attached to some fixed surface, such as in a guest's room, at a guest's home, or wherever guest may access paging signals.

As used herein, the term “video monitor” refers to any display device, mobile or stationary, that connects independently to the communications network, locally or remotely, by wire or wireless, such that guests may access, view, and/or interact with the freestyle reservation system. The video monitor may be a touch-screen television, a computer monitor, an LCD monitor, a CRT monitor, an LCoS monitor, a DLP monitor, a plasma monitor, or some other mobile monitor as understood by one of ordinary skill in the art. Alternatively, the video monitor may be the screen on a personal data assistant, telephone, BlackBerry® or other signal receiver. In certain embodiments, the video monitor may also be incorporated and composite with the guest pager.

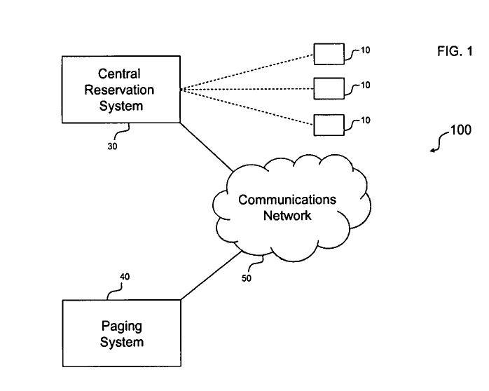

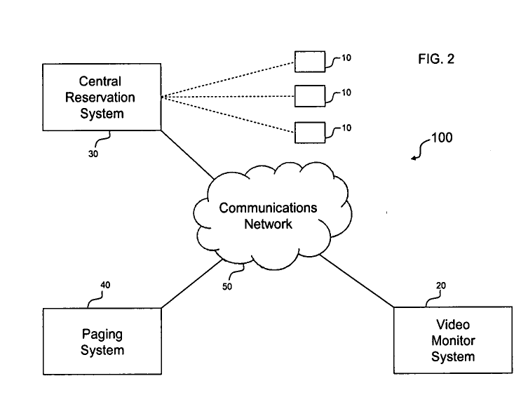

FIG. 1 illustrates one specific embodiment of a freestyle reservation system of the present invention. As shown in FIG. 1, freestyle reservation system 100 may comprise one or more services 10, a central reservation system 30, a paging system 40, and a communications network 50. As shown in FIG. 1, central reservation system 30 and paging system 40 are connected via communications network 50. As shown in FIG. 2, freestyle reservation system 100 may also comprise video monitor system 20, which is connected to central reservation system 30 and paging system 40 via communications network 50.

In specific embodiments, communications network 50 may comprise the internet, a global network that is well known to those of skill in the art. Alternatively, in other specific embodiments, communications network 50 may be any of a wide range of interactive communications links, including an interactive television network, a telephone network, a wireless data transmission network, a two-way cable system, a customized private or public computer network, a local area network, a wide area network, direct communication links, a satellite communication network, a cellular communication network, any other similar or equivalent network as understood by one of ordinary skill in the art, or any combination thereof.

In specific embodiments, the video monitor system 20, central reservation system 30, and paging system 40 may all connect to communications network 50 through a dial up connection, a digital subscriber line connection, a cable modem connection, a fiber connection, a local area network connection, a wide area network connection, any other similar or equivalent connection as understood by one of skill in the art, or any combination thereof.

In specific embodiments, portions of two or more of the video monitor system 20, central reservation system 30, and paging system 40 may reside in the same area, for example upon the same computer server. In such embodiments, communications network 50 may comprise the internal workings of such shared computer server.

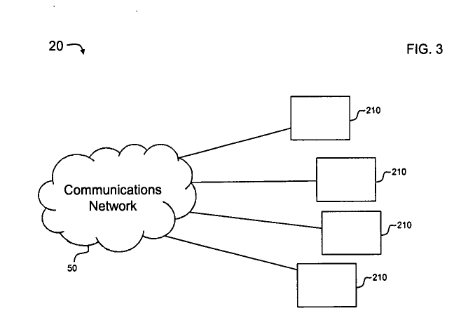

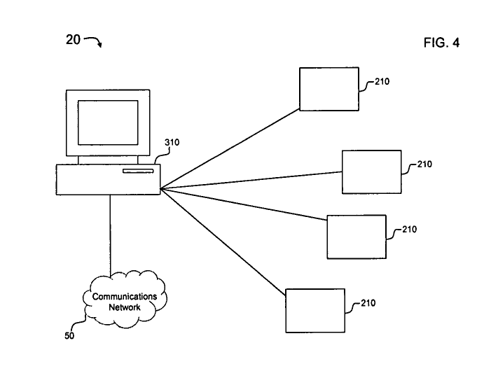

FIG. 3 illustrates one specific embodiment of video monitor system 20. As shown, video monitor system 20 may, in specific embodiments, be comprised simply of one or more video monitors 210 that each connect independently to communications network 50. Alternatively, in another specific embodiment shown in FIG. 4, video monitors 210 may be connected to a central monitor coordination computer 310 either directly or via an interactive communications link, which is in turn connected to communications network 50. In additional specific embodiments, the video monitors 210 may be connected to the central monitor coordination computer 310 via communications network 50 or another similar communications network. In the specific embodiments of video monitor system 20, the video monitors 210 may or may not be connected to each other directly or via an interactive communications link.

In specific embodiments, each video monitor 210 may be comprised of a television monitor, a computer monitor, an LCD monitor, a CRT monitor, an LCoS monitor, a DLP monitor, a plasma monitor, or any other monitor as understood by one of skill in the art. Alternatively, in specific embodiments, the video monitors may be comprised of the screen on a personal data assistant (PDA), a telephone, BlackBerry® or some other mobile monitor as understood by one of skill in the art.

In a specific embodiment, each video monitor 210 may be connected to an input device such as a keyboard, keypad, or some other input device as understood by one skilled in the art. In another specific embodiment, each video monitor 210 may be configured as a touch screen display, as understood by one skilled in the art.

In a specific embodiment, each video monitor 210 may be configured to display reservation availability for one or more of services 10. Alternatively, in specific embodiments, each video monitor 210 may be configured to display information about one or more services 10, such as choices available for selection, menus, hours of operation, cost, levels of service, wine list, drink menu, drink specials, dress code, age limitations, or other information.

In a specific embodiment, each video monitor 210 may be configured with an input device (keyboard, keypad, touch screen, etc.) that allows a user to make a reservation at one or more of the services 10 provided by the host organization, for a specific time and date. In a specific embodiment, the user may also be able to use the input device to peruse information about the services 10, such as choices available for selection, menus, hours of operation, cost, levels of service, wine list, drink menu, drink specials, dress code, age limitations, or other information.

In a specific embodiment, central reservation system 30 serves as a database for reservation times for the one or more provided services 10. Thus, central reservation system 30 maintains reservation information for each service 10, including, e.g., its hours of operation, number of tables, seats or timeslots available, number of tables, seats, or timeslots reserved, and other information as understood by one of skill in the art, such as choices available for selection, menus, hours of operation, costs, levels of service, wine lists, drink menus, drink specials, dress code, age limitations, or other information.

In specific embodiments, central reservation system 30 may be a computer which acts as a server for freestyle reservation system 100. Further, in a specific embodiment, central reservation system 30 may provide real-time reservation information for one or more services 10 to one or more of video monitors 210. Such real-time reservation information may include the number of tables, seats, and/or timeslots available, number of tables, seats, and/or timeslots reserved, the choices and options available for selection at the service 10, and other information as understood by one of skill in the art. In one specific embodiment, one or more of the video monitors 210 may be configured with an input device to allow a user to see and review the real-time reservation information.

In a specific embodiment, central reservation system 30 may comprise a computer server, upon which the reservation information for each service 10 may be maintained.

In a specific embodiment, a user may connect to central reservation system 30 via a communications network 50 and access real-time reservation information and, in specific embodiments, make one or more reservations via a menu-driven phone system, a video monitor 210, or some other instrumentality as understood by one of skill in the art. The user may make a reservation for a set number of people or a defined group, or request a table, seat or timeslot alone or with others. The user may also provide the system with the criteria for the reservation and service, such as providing the number of people in the reservation and the type of reservation and other criteria, such as a reservation for two people at 9:00 pm that evening for a restaurant with Italian cuisine. The system will then provide the user with information as to whether the reservation can be fulfilled under the criteria and whether there are any choices for the user under the criteria, such as whether there is more than one Italian restaurant, located within or outside the host organization, available for that size party at the provided time, or if not, provide other alternatives to the user, such as alternate times, dates, restaurants and/or cuisines that, specifically, may fit or come close to one or more of the user's provided criteria.

In a specific embodiment, services 10 may be provided by another entity organized outside of or separate from the host organization; i.e., an “external service provider.” The services 10 outside the host organization may connect to the central reservation system 30, such that guests may make or change reservations, or view service information, for services provided by the external service provider just as they may for services provided by the host organization. In a specific embodiment, an external service provider may contract with the host organization, and/or pay a fee, or enter into some other form of agreement with the host organization to allow its services 10 to be a part of the central reservation system 30. Examples of such external service providers offering services to guests at the host organization include, but are not limited to, restaurants, restaurant chains, golf courses, athletic facilities, racquet clubs, casinos, tour guides or similar organizations providing excursions from the host organization, theaters, spas, hotels, cruise ships, airlines, bus lines, taxi services, limousine services, cleaning services, laundry services, swimming pools, or providers of virtually any other guest service.

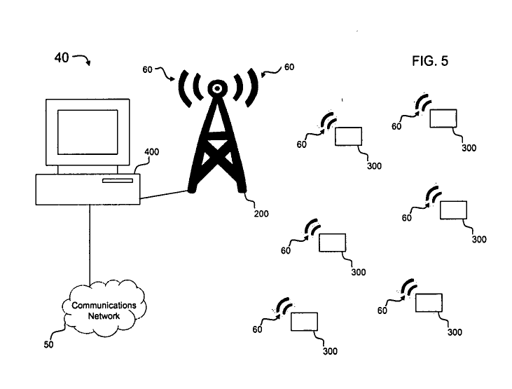

In a specific embodiment depicted in FIG. 5, paging system 40 may be comprised of a central paging system computer 400, a central paging system transmitter 200 and one or more guest pagers 300. In a specific embodiment, central paging system computer 400 is connected to central paging system transmitter 200 either directly or via an interactive communications link. Alternatively, in a specific embodiment, central paging system computer 400 is connected to central paging system transmitter 200 via communications network 50.

In a specific embodiment, central paging transmitter 200 is equipped to transmit paging signals 60 to guest pagers 300. In a specific embodiment, each guest pager 300 is equipped to receive paging signals 60 from central paging transmitter 200. In specific embodiments, paging signals 60 may be comprised of radio frequency (RF) signals, with each guest pager 300 being assigned a specific radio frequency range. In other specific embodiments, each paging signal 60 may be an infrared signal or any other type of wireless communication signal as understood by one of skill in the art.

In a specific embodiment, guest pagers 300 are portable devices capable of being carried on each guest's person, and are capable of receiving paging signals 60 within a certain geographical area. In another specific embodiment, guest pagers 300 are stationary and attached to some fixed surface, such as a surface in guest's room on a cruise ship. In a specific embodiment where guest pagers 300 are stationary, paging signals 60 need not be wireless and may be transmitted via communications network 50 or some other interactive communications link.

In a specific embodiment, guest pagers 300 are portable devices capable of receiving paging signals 60 via electronic mail, and capable of being carried on each guest's person, such as PDAs, laptop computers with internet connectivity by wire or wireless, interactive watches, cell phones, BlackBerry®, Palm® handhelds, mobile managers, etc. Such guest pagers 300 may be provided by the host organization or the pagers may be ones carried (i.e., owned or in the possession of prior) by the guest and the paging signals may be sent to them, as recognized by one of skill in the art. In another specific embodiment, guest pagers 300 are stationary and attached to some fixed surface, such as a surface at guest's home; or a guest pager may be a component part of a computer wherever guest accesses electronic mail, such as at guest's home, at the public library, or at an internet café.

In a specific embodiment, each guest pager 300 is equipped with a guest notification mechanism to alert the guest upon receipt of a paging signal 60. In specific embodiments, this guest notification mechanism may comprise a vibrating mechanism, a series of light-emitting-diodes (LEDs), any other mechanism capable of attracting the guests attention, or any combination thereof. In specific embodiments, paging signal 60 may comprise a textual or graphical message that, once received by a guest pager 300, may be displayed to the guest on a video screen on that guest pager 300. In one embodiment, the video monitor system 20 may be the video screen on the guest pager 300.

In specific embodiments, service 10 may be a restaurant, and paging system 40 may be used to notify guests that their reserved table at a restaurant 10 is ready. Alternatively, in specific embodiments, paging system 40 may be used to notify guests at the time of (or a certain preset time prior to) a scheduled reservation at a restaurant 10. Alternatively, in specific embodiments, paging system 40 may be used to notify guests that an unreserved table at a restaurant 10 is available.

In a specific embodiment, the host organization may be a cruise ship, and certain aspects of the freestyle reservation system 100 may be located upon the cruise ship. For example, in a specific embodiment, services 10 may be located upon a cruise ship. In another specific embodiment, central reservation system 30 may be located upon a cruise ship. In another specific embodiment, paging system 40 may be located upon a cruise ship. In another specific embodiment, communications network 50 may be located upon a cruise ship, and in yet another specific embodiment, communications network 50 may be integrated with a cruise ship's existing communications network.

In a specific embodiment wherein certain aspects of freestyle reservation system 100 may be located on a cruise ship, one or more video monitors 210 may be located within guest rooms on that cruise ship. Specifically, the video monitors 210 may be televisions within the guest rooms, and in specific embodiments, guests may use the television remote control as an input device connected to the television to peruse services, reservation information, or make reservations for one or more services 10.

In specific embodiments, the freestyle reservation system 100 may be used by guests on a cruise ship to create reservations for multiple services 10 located upon the cruise ship using central reservation system 30 and, at times, video monitor system 20. It may then provide guests with a page at the time of their reservations via paging system 40. In this manner, the freestyle reservation system 100 provides a comprehensive pre-service experience for the guests.

In yet another embodiment, the present invention relates to methods of making a restaurant reservation on a ship using the systems of the present invention.

In another embodiment, information as to the availability of tables, seatings, or timeslots may be input to and updated on the central reservation system so as to dynamically track the reservation status of tables, seatings, or timeslots in real time. Such information may be input by waiters or other service staff. Such reservation status information may include, in the example of a restaurant, when the table is set and ready for guests, when the table is occupied with menus distributed, when orders are taken, when food is on its way, when the meal is under way, when the meal is over and the table ready for its bill, and when the table is waiting to be cleared and re-set.

In another specific embodiment, this real-time, up-to-date reservation status information may be accessed and viewed by guests via the video monitor system, so they may gauge the amount of time before their tables, seatings or timeslots become available, and plan accordingly. The reservation status information may also be displayed on monitors available to restaurant or other service managers for aid in booking, or viewed by restaurant galley crew or other service staff to allow them to time their production to the status reports pertaining to table, seating or timeslot usage.

The reservation status information regarding availability of tables, seatings or timeslots that is accumulated at the end of any particular work period may also be stored and used to provide productivity data to the service's management, to aid in budgeting, purchasing, business development, etc.

In another embodiment, information as to the availability of tables, seatings, or timeslots may be input to and updated on the central reservations system by means of, e.g., a radio frequency hand-held device, by sensors or remote surveillance.

What is claimed is:

1. A freestyle reservation system comprising: a video monitor system; a central reservation system; a paging system; and a communications network,
wherein said central reservation system is connected to said video monitor system and said paging system via said communications network; and wherein said central reservation system maintains reservation data for one or more services.

2. The freestyle reservation system of claim 1, wherein said central reservation system comprises a computer which acts as a server for said freestyle reservation system and provides a central database of reservations for said one or more services.

3. The freestyle reservation system of claim 1, wherein said video monitor system comprises one or more video monitors and wherein said central reservation system is connected to said one or more video monitors via said communications network and provides real-time reservation information to said one or more video monitors.

4. The freestyle reservation system of claim 3, wherein said video monitor is equipped with a touch screen.

5. The freestyle reservation system of claim 3, wherein said video monitor is a display device selected from one or more of the group consisting of: a touch-screen television, a computer monitor, an LCD monitor, a CRT monitor, an LCoS monitor, a DLP monitor, a plasma monitor, the screen on a personal data assistant, and the screen on a telephone.

6. The freestyle reservation system of claim 3, wherein said video monitor system connects to said central reservation system through a type of connection selected from one or more of the group consisting of: a dial-up connection, a digital subscriber line connection, a cable modem connection, a fiber connection, a local area network connection, and a wide area network connection.

7. The freestyle reservation system of claim 1, wherein said paging system comprises: a central paging system computer; a central paging system transmitter; and one or more guest pagers, wherein said central paging system computer is connected to said central paging system transmitter, and wherein said central paging system transmitter activates said one or more guest pagers by transmitting radio signals in the appropriate frequency range.

8. The freestyle reservation system of claim 7, wherein said central paging system computer is connected to said central reservation system computer via said central reservation system network.

9. The freestyle reservation system of claim 3, further comprising one or more guest rooms containing televisions, wherein said one or more video monitors comprise one or more of said televisions.

10. The freestyle reservation system of claim 1, wherein said communications network is integral with the existing communications network of a host organization.

11. The freestyle reservation system of claim 9, wherein said freestyle reservation system can be accessed using a menu on said guest room televisions using a television remote control.

12. The freestyle reservation system of claim 1, wherein guests have access to view, make and change reservations for any of said services.

13. The freestyle reservation system of claim 1, wherein guests view, make and change reservations at the physical site of said services.

14. The freestyle reservation system of claim 1, wherein said reservation data comprises services provided by an external service provider.

15. The freestyle reservation system of claim 14, wherein guests have access to view, make and change reservations for any of said services provided by said external service provider.

16. The freestyle reservation system of claim 14, wherein guests have access to view service information for any of said services provided by said external service provider.

17. The freestyle reservation system of claim 14, wherein said external service provider enters into agreement with the host organization to permit its services to be a part of the central reservation system.

18. The freestyle reservation system of claim 14, wherein said services provided by said external service provider comprise one or more of the group consisting of: restaurants, restaurant chains, golf courses, athletic facilities, racquet clubs, casinos, tour guides or similar organizations providing excursions from the host organization, theaters, spas, hotels, cruise ships, airlines, bus lines, taxi services, limousine services, cleaning services, laundry services, and swimming pools.

19. The freestyle reservation system of claim 14, wherein said external service provider is a provider selected from one or more of the group consisting of: restaurant, restaurant chain, golf course, athletic facility, racquet club, casino, tour guide, organization providing excursions from the host organization, theater, spa, hotel, cruise ship, airline, bus line, taxi service, limousine service, cleaning service, laundry service, and swimming pool.

20. The freestyle reservation system of claim 1, wherein guests have access to view information about said services.

21. The freestyle reservation system of claim 20, wherein said information is a type of information selected from one or more of the group consisting of: a menu, hours of operation, levels of service, a wine list, drink menu, drink specials, dress code, age limitations, cost of admission, cost for services, and cost of items.

22. The freestyle reservation system of claim 12, wherein said access comprises remote access.

23. The freestyle reservation system of claim 12, wherein said access to service information is via an instrumentality selected from one or more of the group consisting of: the internet, a menu driven phone system, a personal computer, a laptop computer, electronic mail, and a personal data assistant.

24. The freestyle reservation system of claim 22, wherein electronic security is ensured for said remote access to information by use of an instrumentality selected from one or more of the group consisting of: data encryption keys, user authorization codes, and a unique user name and password.

25. The freestyle reservation system of claim 7, wherein guests are paged by said paging system at a preset time to remind said guests of their reservation.

26. The freestyle reservation system of claim 1, wherein reservation availability information is input to the central reservation system in real-time, so as to dynamically track said reservation availability status.

27. The freestyle reservations system of claim 26, wherein said availability information applies to restaurant reservations and said information comprises one or data selected from the group consisting of: when the table is set and ready for guests; when the table is occupied with menus distributed; when orders are taken; when food is on its way to the table; when the meal is under way; when the meal is over and the table ready for its bill; and when the table is waiting to be cleared and reset.

28. The freestyle reservation system of claim 26, wherein said reservation availability information is input by waiters or other service staff.

29. The freestyle reservation system of claim 26, wherein said reservation availability information is input to the central reservations system by using one or more instrumentalities selected from the groups consisting of: a radio frequency hand-held device, sensors, and remote surveillance.

30. The freestyle reservation system of claim 26, wherein said reservation availability information is accessed and viewed by guests via the video monitor system.

31. The freestyle reservation system of claim 26, wherein said reservation availability information is viewed by service staff via the video monitor system, for aid in planning and coordinating service.

32. The freestyle reservation system of claim 26, wherein said reservation availability information is stored in the central reservation system for one or more uses selected from the group consisting of: providing productivity data to service management; budgeting; purchasing; advertising; and business development.

33. The freestyle reservation system of claim 1, wherein guests can make a reservation for a table, seat or timeslot for a specific number of people, or make a reservation for a table, seat or timeslot by themselves or with other guests.

34. The freestyle reservation system of claim 1, wherein said reservation data is data for a type of reservation selected from one or more of the group consisting of: a reservation, an appointment, a booking, a retainment, and a timeslot.

35. The freestyle reservation system of claim 1, wherein said service is a food-serving establishment selected from one or more of the group consisting of: a restaurant, a café, a coffee shop, a bistro, a pizza parlor, and a sushi bar.

36. The freestyle reservation system of claim 1, wherein said service is a beverage-serving establishment selected from one or more of the group consisting of: a café, a coffee shop, an espresso bar, a bar, a lounge, a nightclub, a pub, and a tavern.

37. The freestyle reservation system of claim 1, wherein said service is a personal service selected from one or more of the group consisting of: room service, dry cleaning, laundry, child sitting, and butler service.

38. The freestyle reservation system of claim 1, wherein said service is a form of entertainment selected from one or more of the group consisting of: a show, a disco, karaoke, bowling, the theater, a party, and a concert.

39. The freestyle reservation system of claim 1, wherein said service is an athletic activity selected from one or more of the group consisting of: rock wall climbing, surfing, golf, racquet sports, aerobics classes, step classes, Pilates classes, Spinning® classes, and yoga classes.

40. The freestyle reservation system of claim 1, wherein said service is an activity selected from one or more of the group consisting of: an excursion, an auction, and a children's activity.

41. The freestyle reservation system of claim 1, wherein said paging system connects to said central reservation system through a type of connection selected from one or more of the group consisting of: a dial-up connection, a digital subscriber line connection, a cable modem connection, a fiber connection, a local area network connection, and a wide area network connection.

42. A method comprising: making a reservation for a service through a central reservation system, wherein said central reservation system comprises a video monitor system, a paging system, and a communications network, wherein said central reservation system is connected to said video monitor system and said paging system is connected via said communications network, and wherein said central reservation system maintains reservation data for one or more services.

43. The method of claim 42, wherein said central reservation system comprises a computer that acts as a server for the system and provides a central database of reservations for all of said one or more services.

44. The method of claim 42, wherein said video monitor system comprises one or more video monitors and wherein said central reservation system is connected to said one or more video monitors via said communications network and provides real-time reservation information to said one or more video monitors.

45. The method of claim 44, wherein said video monitor is equipped with a touch screen.

46. The method of claim 44, wherein said video monitor is a display device selected from one or more of the group consisting of: a touch-screen television, a computer monitor, an LCD monitor, a CRT monitor, an LCoS monitor, a DLP monitor, a plasma monitor, the screen on a personal data assistant, and the screen on a telephone.

47. The method of claim 44, wherein said video monitor system connects to said central reservation system through a type of connection selected from one or more of the group consisting of: a dial-up connection, a digital subscriber line connection, a cable modem connection, a fiber connection, a local area network connection, and a wide area network connection.

48. The method of claim 42, wherein said paging system comprises: a central paging system computer; a central paging system transmitter; and one or more guest pagers, wherein said central paging system computer is connected to said central paging system transmitter, and wherein said central paging system transmitter activates said one or more guest pagers by transmitting radio signals in the appropriate frequency range.

49. The method of claim 48, wherein said central paging system computer is connected to said central reservation system computer via said central reservation system network.

50. The method of claim 44, further comprising one or more guest rooms containing televisions, wherein said one or more video monitors comprise one or more of said televisions.

51. The method of claim 42, wherein said communications network is integral with the existing communications network of a host organization.

52. The method of claim 50, wherein said freestyle reservation system can be accessed using a menu on said guest room televisions using a television remote control.

53. The method of claim 42, wherein guests have access to view, make and change reservations for any of said services.

54. The method of claim 42, wherein guests view, make and change reservations at the physical site of said services.

55. The method of claim 42, wherein said reservation data comprises services provided by an external service provider.

56. The method of claim 55, wherein guests have access to view, make and change reservations for any of said services provided by said external service provider.

57. The method of claim 55, wherein guests have access to view service information for any of said services provided by said external service provider.

58. The method of claim 55, wherein said external service provider enters into agreement with the host organization to permit its services to be a part of the central reservation system.

59. The method of claim 55, wherein said services provided by said external service provider comprise one or more of the group consisting of: restaurants, restaurant chains, golf courses, athletic facilities, racquet clubs, casinos, tour guides or similar organizations providing excursions from the host organization, theaters, spas, hotels, cruise ships, airlines, bus lines, taxi services, limousine services, cleaning services, laundry services, and swimming pools.

60. The method of claim 55, wherein said external service provider is a provider selected from one or more of the group consisting of: restaurant, restaurant chain, golf course, athletic facility, racquet club, casino, tour guide, organization providing excursions from the host organization, theater, spa, hotel, cruise ship, airline, bus line, taxi service, limousine service, cleaning service, and swimming pool.

61. The method of claim 42, wherein guests have access to view information about said services.

62. The method of claim 61, wherein said information is a type of information selected from one or more of the group consisting of: a menu, hours of operation, levels of service, a wine list, drink menu, drink specials, dress code, age limitations, cost of admission, cost for services, and cost of items.

63. The method of claim 53, wherein said access comprises remote access.

64. The method of claim 53, wherein said access to service information is via an instrumentality selected from one or more of the group consisting of: the internet, a menu driven phone system, a personal computer, a laptop computer, electronic mail, and a personal data assistant.

65. The method of claim 63, wherein electronic security is ensured for said access to information by use of an instrumentality selected from one or more of the group consisting of: data encryption keys, user authorization codes, and a unique user name and password.

66. The method of claim 48, wherein guests are paged by said paging system at a preset time to remind them of their reservation.

67. The method of claim 42, wherein reservation availability information is input to the central reservation system in real-time, so as to dynamically track said reservation availability status.

68. The method of claim 67, wherein said availability information applies to restaurant reservations and said information comprises one or data selected from the group consisting of: when the table is set and ready for guests; when the table is occupied with menus distributed; when orders are taken; when food is on its way to the table; when the meal is under way; when the meal is over and the table ready for its bill; and when the table is waiting to be cleared and reset.

69. The method of claim 67, wherein said reservation availability information is input by waiters or other service staff.

70. The method of claim 67, wherein said reservation availability information is input to the central reservations system by using one or more instrumentalities selected from the groups consisting of: a radio frequency hand-held device, sensors, and remote surveillance.

71. The method of claim 67, wherein said reservation availability information is accessed and viewed by guests via the video monitor system.

72. The method of claim 67, wherein said reservation availability information is viewed by service staff via the video monitor system, for aid in planning and coordinating service.

73. The method of claim 67, wherein said reservation availability information is stored in the central reservation system for one or more uses selected from the group consisting of: providing productivity data to service management; budgeting; purchasing; advertising; and business development.

74. The method of claim 42, wherein guests can make a reservation for a table, seat or timeslot for a specific number of people, or make a reservation for a table, seat or timeslot by themselves or with other guests.

75. The method of claim 42, wherein said reservation data is data for a type of reservation selected from one or more of the group consisting of: a reservation, an appointment, a booking, a retainment, and a timeslot.

76. The method of claim 42, wherein said service is a food-serving establishment selected from one or more of the group consisting of: a restaurant, a café, a coffee shop, a bistro, a pizza parlor, and a sushi bar.

77. The method of claim 42, wherein said service is a beverage-serving establishment selected from one or more of the group consisting of: a café, a coffee shop, an espresso bar, a bar, a lounge, a nightclub, a pub, and a tavern.

78. The method of claim 42, wherein said service is a personal service selected from one or more of the group consisting of: room service, dry cleaning, laundry, child sitting, and butler service.

79. The method of claim 42, wherein said service is a form of entertainment selected from one or more of the group consisting of: a show, a disco, karaoke, bowling, the theater, a party, and a concert.

80. The method of claim 42, wherein said service is an athletic activity selected from one or more of the group consisting of: rock wall climbing, surfing, golf, racquet sports, aerobics classes, step classes, Pilates classes, Spinning® classes, and yoga classes.

81. The method of claim 42, wherein said service is an activity selected from one or more of the group consisting of: an excursion, an auction, and a children's activity.

82. The method of claim 48, wherein said paging system connects to said central reservation system through a type of connection selected from one or more of the group consisting of: a dial-up connection, a digital subscriber line connection, a cable modem connection, a fiber connection, a local area network connection, and a wide area network connection.
